(19) United States
(12) Patent Application Publication
(10) Pub. No.: US 2015/0027143 A1
(43) Pub. Date: Jan. 29, 2015

(54) CABIN EXHAUST AIR HEAT RECOVERY SYSTEM INCLUDING A HEAT PUMP SYSTEM HAVING A NON-FREEZING EVAPORATOR

(71) Applicant: GM Global Technology Operations LLC, Detroit, MI (US)

(72) Inventors: Mark D. Nemesh, Troy, MI (US); Mukund S. Wankhede, Fort Gratiot, MI (US); Bryan M. Styles, South Lyon, MI (US)

(73) Assignee: GM Global Technology Operations LLC, Detroit, MI (US)

(21) Appl. No.: 13/951,833

(22) Filed: Jul. 26, 2013

(51) Int. Cl. B60H 1/00

(52) U.S. Cl. CPC B60H 1/00007
USPC 62/79; 62/244; 62/115

(57) ABSTRACT

A number of variations of the invention may include a product including a cabin exhaust air heat recovery system including a heat pump system having a non-freezing evaporator.

### TECHNICAL FIELD

The field to which the disclosure generally relates to includes vehicle cabin exhaust air heat recovery systems, components thereof and methods of operating the same.

### BACKGROUND

Vehicles may be equipped with a heat pump system.

### SUMMARY OF ILLUSTRATIVE VARIATIONS

A number of variations of the invention may include a product including a cabin exhaust air heat recovery system including a heat pump system having a non-freezing evaporator.

A number of variations of the invention may include a heat pump system having an evaporator and a heat pump condenser housed in the passenger cabin.

A number of variations of the invention may include a heat pump system having an evaporator housed in the passenger cabin and a heat pump condenser housed in the front cabin heating, ventilation and air-conditioning module.

A number of variations of the invention may include a heat pump system having an evaporator housed in the passenger cabin and a heat pump condenser housed outside the passenger cabin and constructed and arranged to provide refrigerant to liquid heat transfer.

Other illustrative variations within the scope of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a cabin exhaust heat recovery system including a heat pump system having a non-freezing evaporator, and a heat pump condenser housed in the passenger cabin according to a number of variations of the invention.

FIG. 1A is a schematic illustration of a cabin exhaust heat recovery system including a heat pump system having a non-freezing evaporator, and a heat pump condenser housed in the passenger cabin according to a number of other variations of the invention.

FIG. 2 is a schematic illustration of a cabin exhaust heat recovery system including a heat pump system having a non-freezing evaporator, and a heat pump condenser housed outside of the passenger cabin and constructed and arranged to provide refrigerant to liquid heat transfer according to a number of variations of the invention.

FIG. 2A is a schematic illustration of a cabin exhaust heat recovery system according to a number of variations of the invention.

### DETAILED DESCRIPTION OF ILLUSTRATIVE VARIATIONS

The following description of the variations is merely illustrative in nature and is in no way intended to limit the invention, its application, or uses.

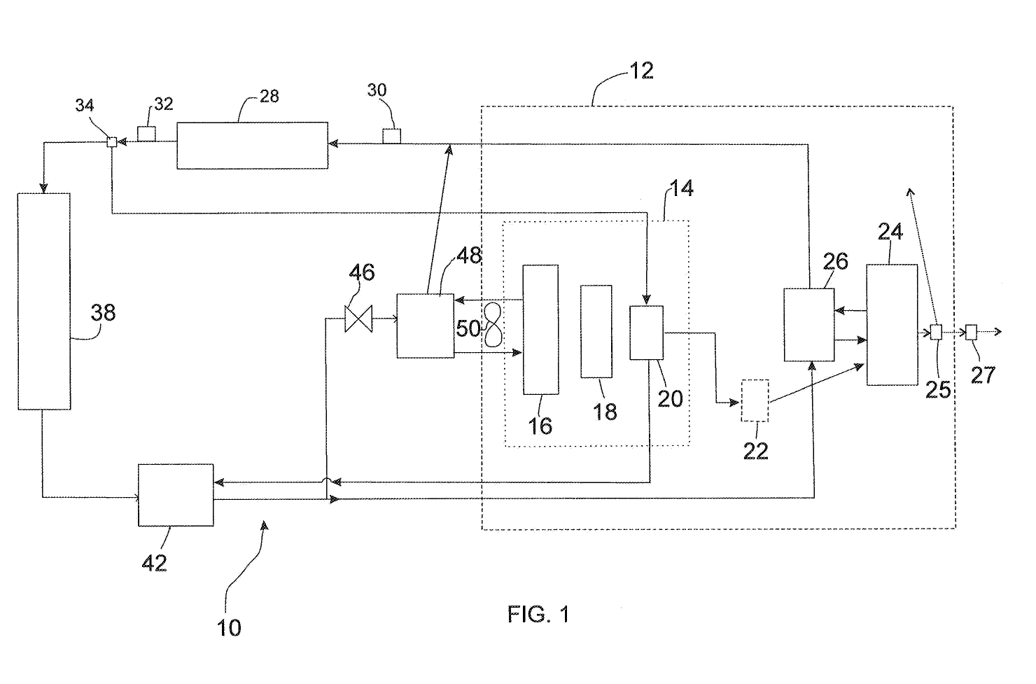

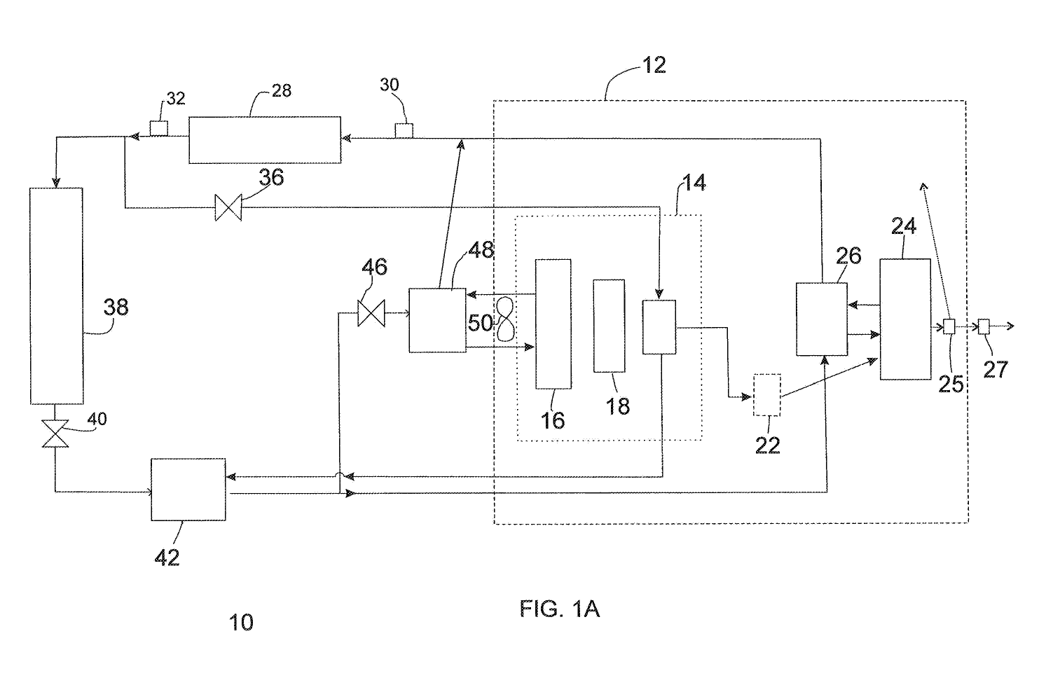

FIGS. 1 and 1A are schematic illustrations of a vehicle 10 including a cabin exhaust heat recovery system including a heat pump system having a non-freezing evaporator, and a heat pump condenser is housed in the passenger cabin 12 according to a number of variations of the invention. The vehicle 10 may include a front heating, ventilation and air conditioning (HVAC) module 14. The module 14 in a number of variations may include a cabin evaporator 16, a coolant heater core 18, and a heat pump condenser 20. A blower or fan 50 may be provided in the HVAC module 14 to draw air, from inside or outside the cabin, across at least the cabin evaporator 16, and/or the coolant heater core 18, and/or the heat pump condenser 20. The blower or fan 50 may force air through the passenger cabin 12. If desired, cabin air may be utilized to cool any air cooled device 22 (e.g., air-cooled APM, battery pack etc.). The device 22 may be equipped with a blower or fan, or an additional blower fan may be provided in the passenger cabin 12. Cabin air and/or air from any air cooled device 22 may be discharged through a rear evaporator 24. Air discharges from the rear evaporator 24 may be discharged into a valve or vent door 25. A valve or vent door 25 may be provided adjacent the air discharged from the rear evaporator 24 may be selectively directed to discharge the rear evaporator air to either outside the passenger cabin 12 via a body pressure relief valve 27; or the valve or vent door 25 may be adjusted to discharge the rear evaporator air into the passenger compartment cabin 12 through rear air-conditioning outlets provided in the vehicle. The rear evaporator 24 may be positioned in the vehicle passenger cabin 12, for example underneath or behind a rear passenger seat (not shown).

Heat may be recovered from the cabin air utilizing the rear evaporator 24 when the same is operated in a heat pump cycle mode. The rear evaporator 24 absorbs heat from the cabin 12 and/or the air being discharged from the cabin air cooled device 22, by boiling refrigerant flowing through the rear evaporator 24. The refrigerant may travel from the rear evaporator 24 to a compressor 28. The system may include a low side refrigerant pressure sensor 30 upstream of the compressor and a high side refrigerant pressure sensor 32 downstream of the compressor 28. The refrigerant may flow from the compressor 28 through a first three way 34 to the heat pump condenser 20, through a receiver/dryer 42. The first three way valve 34 (shown in FIG. 1A) may be replaced by using both a heat pump condenser refrigerant shutoff valve 36 (shown in FIG. 1) and air conditioning condenser refrigerant shutoff valve 40 (shown in FIG. 1A). From the receiver/dryer 42, the refrigerant may flow to a first expansion valve 26 and back through the rear evaporator 24. A shutoff valve 46 may be after the receiver/driver so that refrigerant may be selectively directed through a second expansion valve 48 and through the front cabin evaporator 16. The refrigerant may flow from the front cabin evaporator 16 back to the compressor 28.

Because the rear evaporator 24 is located in the passenger cabin, for example, behind or underneath the rear passenger seat, if there is any moisture in the air flowing over one side of the rear evaporator 24 the moisture condenses in the passenger cabin which is typically at a temperature of at least 4° C. or higher. Therefore, the rear evaporator 24 is not susceptible to freezing. This is unlike evaporators located outside the passenger cabin and which operate utilizing refrigerant to air heat exchange wherein moisture in the air may condense on the external evaporator and may freeze when the external temperature is near 0° C. or less.

The heat pump system may be operated in a heating mode including recovering heat from the passenger cabin and/or from heat generating devices 22 including by flowing refrigerant through the rear evaporator 24 so that heat from the passenger cabin is utilized to heat and boil the refrigerant, flowing refrigerant from the rear evaporator 24 through the compressor 28, through the air-conditioning condenser 38 or the heat pump condenser 20, through expansion valve 26 and back to the rear evaporator 24.

The heat pump system may be operated in a cooling mode by flowing refrigerant from the compressor 28 to the air-conditioning condenser 38 through the receiver dryer 42, through first expansion valve 26 and through the rear evaporator 24; and/or through a shutoff valve 46 and through the second expansion valve 48 and through the front evaporator 16. Refrigerant flow from both the rear evaporator 24 and/or the front evaporator 16 then flows back to the compressor 28 and then to the air conditioning condenser 38. Blowing air over the rear evaporator 24 operated in the cooling mode may allow cold air to be discharged into the passenger cabin 12 through rear air-conditioning outlets provided in the vehicle.

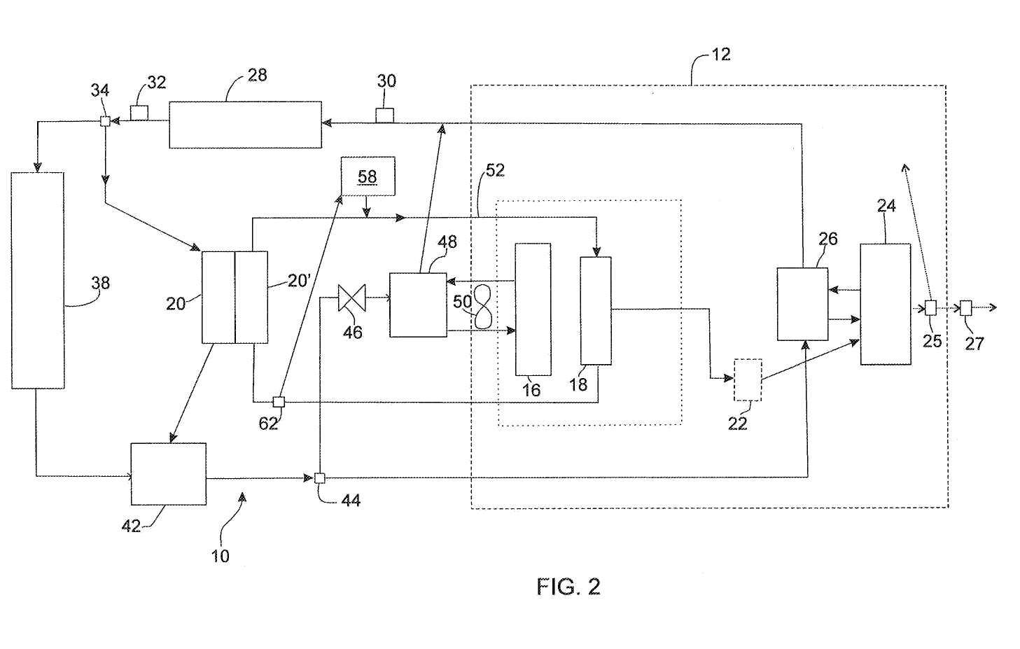

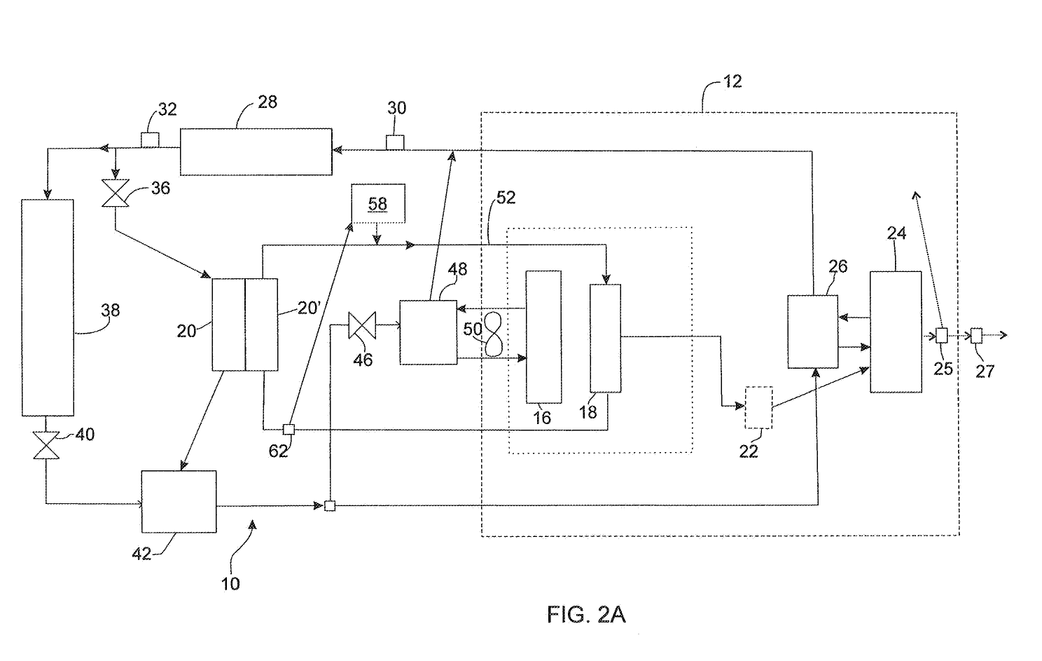

FIGS. 2 and 2A are schematic illustrations of a number of other variations of the invention. In a number of variations of the invention, the vehicle 10 may include a heat pump condenser 20 positioned outside of the passenger cabin 12. The heat pump condenser 20 may include a heat exchanger 20′ portion through which engine coolant liquid may flow so there is refrigerant to coolant liquid heat transfer utilizing the exterior heat pump condenser 20. The vehicle may further include a combustion engine 58. A three way coolant valve 62 may be provided to direct engine coolant liquid from the coolant heater core 18, to either the heat pump condenser 20 or back to the combustion engine 58

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a vehicle comprising: a passenger cabin; a cabin air heat recovery system including a heat pump system comprising a rear evaporator positioned in the passenger cabin.

Variation 2 may include a vehicle as set forth in Variation 1 wherein the heat pump system further comprises a front cabin heating, ventilation and air-conditioning module comprising a front cabin evaporator and a coolant heater core.

Variation 3 may include a vehicle as set forth in Variation 2 wherein the front cabin heating, ventilation and air-conditioning module further comprises a heat pump condenser.

Variation 4 may include a vehicle as set forth in any of Variations 1-3 wherein the vehicle further comprises a heat pump condenser positioned outside of the passenger cabin.

Variation 5 may include a vehicle as set forth in any of Variations 1-4 further comprising a combustion engine, the combustion engine being plumbed to a refrigerant-to-coolant heat pump condenser to provide refrigerant to engine coolant heat transfer Variation 6 may include a vehicle as set forth in any of Variations 1-5 further comprising a vent door constructed and arranged to selectively direct rear evaporator air discharge through rear air-conditioning outlets provided in the vehicle.

Variation 7 may include a vehicle as set forth in any of Variations 1-6 wherein the vent door is also constructed and arranged to selectively direct rear evaporator discharge air out of the passenger cabin.

Variation 8 may include a method comprising; providing a vehicle comprising a passenger cabin, a cabin air heat recovery system including a heat pump system comprising a rear evaporator positioned in the passenger cabin, a compressor, an air-conditioning condenser or the heat pump condenser, and an expansion valve; recovering heat from the passenger cabin comprising operating the heat pump system in a heating mode comprising flowing refrigerant through the rear evaporator so that heat from the passenger cabin and/or cabin air cooled device 22 is utilized to heat and boil the refrigerant, flowing refrigerant from the rear evaporator through the compressor, through the air-conditioning condenser or the heat pump condenser, through expansion valve and back to the rear evaporator.

Variation 9 may include a method as set forth in Variation 8 further comprising flowing passenger cabin air through a heat generating device to cool the heat generating device and heat cabin air, and then flowing the heated cabin air through the rear evaporator.

Variation 10 may include a method as set forth in any of Variations 8-9 wherein the heat pump system further comprises a front cabin heating, ventilation and air-conditioning module comprising a front cabin evaporator and a coolant heater core.

Variation 11 may include a method as set forth in Variation 10 wherein the front cabin heating, ventilation and air-conditioning module further comprises a heat pump condenser.

Variation 12 may include a method as set forth in any of Variations 8-11 wherein the vehicle further comprises a heat pump condenser positioned outside of the passenger cabin.

Variation 13 may include a method as set forth in any of Variations 8-12 further comprising a combustion engine, the combustion engine being plumbed to the heat pump condenser to provide refrigerant to engine coolant liquid heat transfer at the heat pump condenser.

Variation 14 may include a method comprising: providing a vehicle comprising a passenger cabin, a cabin air heat recovery system including a heat pump system comprising a rear evaporator positioned in the passenger cabin, a compressor, an air-conditioning condenser and heat pump condenser,; operating the heat pump system in a cooling mode comprising flowing refrigerant from the compressor to the air-conditioning condenser through the first expansion valve, through the rear evaporator and/or through the second expansion valve and through the front cabin evaporator; and then back to the air conditioning compressor.

Variation 15 may include a method as set forth in Variation 14 further comprising flowing passenger cabin air through a heat generating device to cool the heat generating device and heat cabin air, and then flowing the heated cabin air through the rear evaporator.

Variation 16 may include a method as set forth in any of Variations 14-15 further comprising blowing cabin air over the rear evaporator to cool the cabin air and discharging the cooled cabin air back into the passenger cabin

Variation 17 may include a method as set forth in any of Variations 14-16 wherein the heat pump system further comprises a front cabin heating, ventilation and air-conditioning module comprising a front cabin evaporator and a coolant heater core.

Variation 18 may include a method as set forth in any of Variations 14-17 wherein the front cabin heating, ventilation and air-conditioning module further comprises a heat pump condenser.

Variation 19 may include a method as set forth in any of Variations 14-18 wherein the vehicle further comprises a heat pump condenser positioned outside of the passenger cabin.

Variation 20 may include a method as set forth in any of Variations 14-19 further comprising a combustion engine, the combustion engine being plumbed to the heat pump condenser to provide refrigerant to engine coolant liquid heat transfer at the heat pump condenser.

The above description of select examples of the invention is merely exemplary in nature and, thus, variations or variants thereof are not to be regarded as a departure from the spirit and scope of the invention.

What is claimed is:

1. A vehicle comprising:
a passenger cabin;
a cabin air heat recovery system including a heat pump system comprising a rear evaporator positioned in the passenger cabin.

2. A vehicle as set forth in claim 1 wherein the heat pump system further comprises a front cabin heating, ventilation and air-conditioning module comprising a front cabin evaporator and a coolant heater core.

3. A vehicle as set forth in claim 2 wherein the front cabin heating, ventilation and air-conditioning module further comprises a heat pump condenser.

4. A vehicle as set forth in claim 2 wherein the vehicle further comprises a heat pump condenser positioned outside of the passenger cabin.

5. A vehicle as set forth in claim 4 further comprising a combustion engine, the combustion engine being plumbed to the heat pump condenser to provide refrigerant to engine coolant heat transfer at the heat pump condenser.

6. A vehicle as set forth in claim 1 further comprising a vent door constructed and arranged to selectively direct rear evaporator air discharge into the passenger cabin through rear air-conditioning outlets provided in the vehicle.

7. A vehicle as set forth in claim 6 wherein the vent door is also constructed and arranged to selectively direct rear evaporator air discharge out of the passenger cabin.

8. A method comprising:
providing a vehicle comprising a passenger cabin, a cabin air heat recovery system including a heat pump system comprising a rear evaporator positioned in the passenger cabin, a compressor, an air-conditioning condenser, a heat pump condenser, and an expansion valve;
recovering heat from the passenger cabin comprising operating the heat pump system in a heating mode comprising flowing refrigerant through the rear evaporator so that heat from the passenger cabin is utilized to heat and boil the refrigerant, flowing refrigerant from the rear evaporator through the compressor, through the heat pump condenser, through expansion valve and back to the rear evaporator.

9. A method as set forth in claim 8 wherein the heat pump system further comprises a front cabin heating, ventilation and air-conditioning module comprising a front cabin evaporator and a coolant heater core.

10. A method as set forth in claim 9 wherein the front cabin heating, ventilation and air-conditioning module further comprises a heat pump condenser.

11. A method as set forth in claim 9 wherein the vehicle further comprises a heat pump condenser positioned outside of the passenger cabin.

12. A method as set forth in claim 11 further comprising a combustion engine, the combustion engine being plumbed to the heat pump condenser to provide refrigerant to engine coolant liquid heat transfer at the heat pump condenser.

13. A method as set forth in claim 8 further comprising flowing passenger cabin air through a heat generate device to cool the heat generating device and heat cabin air and then flowing the heated cabin air through the rear evaporator.

14. A method comprising:
providing a vehicle comprising a passenger cabin, a cabin air heat recovery system including a heat pump system comprising a rear evaporator positioned in the passenger cabin, a compressor, an air-conditioning condenser or the heat pump condenser, and an expansion valve;
operating the heat pump system in a cooling mode comprising flowing refrigerant from the compressor, through the air-conditioning condenser, through the first expansion valve, through the rear evaporator and/or through the second expansion valve and through the front cabin evaporator; and then back to the air conditioning compressor.

15. A method as set forth in claim 14 further comprising flowing passenger cabin air through a heat generating device to cool the heat generating device and heat cabin air, and then flowing the heated cabin air through the rear evaporator.

16. A method as set forth in claim 14 further comprising blowing cabin air over the rear evaporator to cool the cabin air and discharging the cooled cabin air back into the passenger cabin

17. A method as set forth in claim 14 wherein the heat pump system further comprises a front cabin heating, ventilation and air-conditioning module comprising a front cabin evaporator and a coolant heater core.

18. A method as set forth in claim 17 wherein the front cabin heating, ventilation and air-conditioning module further comprises a heat pump condenser.

19. A method as set forth in claim 17 wherein the vehicle further comprises a heat pump condenser positioned outside of the passenger cabin.

20. A method as set forth in claim 19 further comprising a combustion engine, the combustion engine being plumbed to the heat pump condenser to provide refrigerant to engine coolant heat transfer at the heat pump condenser.
